(19) United States
(12) Patent Application Publication
(10) Pub. No.: US 2026/0370060 A1
(43) Pub. Date: Nov. 19, 2026

(54) WIRELESS POWER TRANSFER FOR ELECTRONIC DEVICES

(71) Applicant: Apple Inc., Cupertino, CA (US)

(72) Inventors: Tzu-Jui LIN, Auckland (NZ); Zaid A. ABUKHALAF, San Diego, CA (US); Alin I. GHERGHESCU, Campbell, CA (US); Stephen C. TERRY, San Jose, CA (US)

(21) Appl. No.: 19/676,426

(22) Filed: May 13, 2026

Related U.S. Application Data
(60) Provisional application No. 63/998,733, filed on Mar. 6, 2026.
(60) Provisional application No. 63/879,507, filed on Sep. 10, 2025.
(60) Provisional application No. 63/807,173, filed on May 16, 2025.

(51) Int. Cl. H02J 50/80; H02J 50/10; H02J 50/90

(52) U.S. Cl. CPC H02J 50/80; H02J 50/10; H02J 50/90

(57) ABSTRACT

Communication techniques for wireless power transmitters and wireless power receivers are described. In some embodiments, a wireless power transmitter negotiates power transfer using different wireless charging protocols based on a received message from a wireless power receiver. In some embodiments, the wireless power transmitter provides wireless power transfer to the wireless power receiver.

### CROSS-REFERENCE TO RELATED APPLICATIONS

This application claims priority to U.S. Provisional Application Serial No. 63/807,173, entitled “WIRELESS POWER TRANSFER FOR ELECTRONIC DEVICES,” filed May 16, 2025, U.S. Provisional Application Serial No. 63/879,507, entitled “WIRELESS POWER TRANSFER FOR ELECTRONIC DEVICES,” filed Sep. 10, 2025, and U.S. Provisional Application Serial No. 63/998,733, entitled “WIRELESS POWER TRANSFER FOR ELECTRONIC DEVICES,” filed Mar. 6, 2026. The contents of these applications are hereby incorporated by reference in their entirety.

### FIELD

The present disclosure relates generally to wireless power transfer systems and computer-implemented methods, and more specifically to techniques for negotiating and/or transferring wireless power.

### BACKGROUND

Wireless power transfer is used in various electronic devices. For example, smart phones, tablet computers, smart watches, wireless earphones, styluses, etc. may employ wireless power transfer to facilitate charging of batteries within the devices.

### SUMMARY

A wireless power transmitter is described, in accordance with some embodiments, The wireless power transmitter comprises: a wireless power transfer coil; an inverter configured to receive input power and to generate an output to the wireless power transfer coil to wirelessly deliver power to a wireless power receiver; and a controller coupled to the inverter and to the wireless power transfer coil that controls the inverter to regulate wireless power transfer to the wireless power receiver, wherein the controller communicates with the wireless power receiver by: detecting presence of the wireless power receiver; subsequent to detecting presence of the wireless power receiver, transmitting, to the wireless power receiver, a first startup message as part of a digital ping; and subsequent to transmitting the first startup message: in accordance with receiving, from the wireless power receiver, a first type of message that is a response based on the first startup message, negotiating wireless power transfer, using a first charging protocol, with the wireless power receiver; and in accordance with receiving, from the wireless power receiver, a second type of message, different from the first type of message, that is not a response based on the first startup message, negotiating wireless power transfer, using a second charging protocol, with the wireless power receiver.

A computer-readable storage medium is described, in accordance with some embodiments. The computer-readable storage medium stores one or more programs configured to be executed by one or more processors of a wireless power transmitter that includes a wireless power transfer coil and an inverter configured to receive input power and to generate an output to the wireless power transfer coil to wirelessly deliver power to a wireless power receiver, the one or more programs including instructions for: detecting presence of the wireless power receiver; subsequent to detecting presence of the wireless power receiver, transmitting, to the wireless power receiver, a first startup message as part of a digital ping; and subsequent to transmitting the first startup message: in accordance with receiving, from the wireless power receiver, a first type of message that is a response based on the first startup message, negotiating wireless power transfer, using a first charging protocol, with the wireless power receiver; and in accordance with receiving, from the wireless power receiver, a second type of message, different from the first type of message, that is not a response based on the first startup message, negotiating wireless power transfer, using a second charging protocol, with the wireless power receiver. In some embodiments, the computer-readable storage medium is a non-transitory computer-readable storage medium. In some embodiments, the computer-readable storage medium is a transitory computer-readable storage medium.

A method is described, in accordance with some embodiments. The method is performed at a wireless power transmitter. The method comprises: detecting presence of a wireless power receiver; subsequent to detecting presence of the wireless power receiver, transmitting, to the wireless power receiver, a first startup message as part of a digital ping; and subsequent to transmitting the first startup message: in accordance with receiving, from the wireless power receiver, a first type of message that is a response based on the first startup message, negotiating wireless power transfer, using a first charging protocol, with the wireless power receiver; and in accordance with receiving, from the wireless power receiver, a second type of message, different from the first type of message, that is not a response based on the first startup message, negotiating wireless power transfer, using a second charging protocol, with the wireless power receiver.

A wireless power transmitter is described, in accordance with some embodiments. The wireless power transmitter comprises: a wireless power transfer coil; an inverter configured to receive input power and to generate an output to the wireless power transfer coil to wirelessly deliver power to a wireless power receiver; and a controller coupled to the inverter and to the wireless power transfer coil that controls the inverter to regulate wireless power transfer to the wireless power receiver, wherein the controller communicates with the wireless power receiver by: detecting presence of the wireless power receiver; subsequent to detecting presence of the wireless power receiver, transmitting, to the wireless power receiver, a first startup message as part of a digital ping; and subsequent to transmitting the first startup message: in accordance with receiving, from the wireless power receiver, a first type of message that is a response based on the first startup message, providing wireless power, via the wireless power transfer coil, to the wireless power receiver; and in accordance with receiving, from the wireless power receiver, a second type of message, different from the first type of message, that is not a response based on the first startup message, performing a negotiation for wireless power transfer with the wireless power receiver.

A computer-readable storage medium is described, in accordance with some embodiments. The computer-readable storage medium stores one or more programs configured to be executed by one or more processors of a wireless power transmitter that includes a wireless power transfer coil and an inverter configured to receive input power and to generate an output to the wireless power transfer coil to wirelessly deliver power to a wireless power receiver, the one or more programs including instructions for: detecting presence of the wireless power receiver; subsequent to detecting presence of the wireless power receiver, transmitting, to the wireless power receiver, a first startup message as part of a digital ping; and subsequent to transmitting the first startup message: in accordance with receiving, from the wireless power receiver, a first type of message that is a response based on the first startup message, providing wireless power, via the wireless power transfer coil, to the wireless power receiver; and in accordance with receiving, from the wireless power receiver, a second type of message, different from the first type of message, that is not a response based on the first startup message, performing a negotiation for wireless power transfer with the wireless power receiver. In some embodiments, the computer-readable storage medium is a non-transitory computer-readable storage medium. In some embodiments, the computer-readable storage medium is a transitory computer-readable storage medium.

A method is described, in accordance with some embodiments. The method is performed at a wireless power transmitter. The method comprises: detecting presence of a wireless power receiver; subsequent to detecting presence of the wireless power receiver, transmitting, to the wireless power receiver, a first startup message as part of a digital ping; and subsequent to transmitting the first startup message: in accordance with receiving, from the wireless power receiver, a first type of message that is a response based on the first startup message, providing wireless power, via a wireless power transfer coil of the wireless power transmitter, to the wireless power receiver; and in accordance with receiving, from the wireless power receiver, a second type of message, different from the first type of message, that is not a response based on the first startup message, performing a negotiation for wireless power transfer with the wireless power receiver.

### BRIEF DESCRIPTION OF THE DRAWINGS

FIG. 1 illustrates a simplified block diagram of a wireless power transfer system.

FIGS. 2A-2B illustrate example interactions between a power transmitter and a power receiver.

FIG. 3 is a flow diagram illustrating example processes for interactions between wireless power systems, in accordance with some embodiments.

FIG. 4 is a flow diagram illustrating example processes for interactions between wireless power systems, in accordance with some embodiments.

FIGS. 5A-5B illustrate example power session request and power session status messages.

FIG. 6 illustrates an example process for communicating a power session status message.

FIG. 7 is a flow diagram illustrating example processes for interactions between wireless power systems, in accordance with some embodiments

FIGS. 8A-8G illustrate example scenarios for a PRx and PTx that are operating on mismatched standards, in accordance with some embodiments.

### DETAILED DESCRIPTION

In the following description, for purposes of explanation, numerous specific details are set forth to provide a thorough understanding of the disclosed concepts. As part of this description, some of this disclosure’s drawings represent structures and devices in block diagram form for sake of simplicity. In the interest of clarity, not all features of an actual implementation are described in this disclosure. Moreover, the language used in this disclosure has been selected for readability and instructional purposes, has not been selected to delineate or circumscribe the disclosed subject matter. Rather the appended claims are intended for such purpose.

Various embodiments of the disclosed concepts are illustrated by way of example and not by way of limitation in the accompanying drawings in which like references indicate similar elements. For simplicity and clarity of illustration, where appropriate, reference numerals have been repeated among the different figures to indicate corresponding or analogous elements. In addition, numerous specific details are set forth to provide a thorough understanding of the implementations described herein. In other instances, methods, procedures, and components have not been described in detail so as not to obscure the related relevant function being described. References to “an,” “one,” or “another” embodiment in this disclosure are not necessarily to the same or different embodiment, and they mean at least one. A given figure may be used to illustrate the features of more than one embodiment, or more than one species of the disclosure, and not all elements in the figure may be required for a given embodiment or species. A reference number, when provided in a given drawing, refers to the same element throughout the several drawings, though it may not be repeated in every drawing. The drawings are not to scale unless otherwise indicated, and the proportions of certain parts may be exaggerated to better illustrate details and features of the present disclosure.

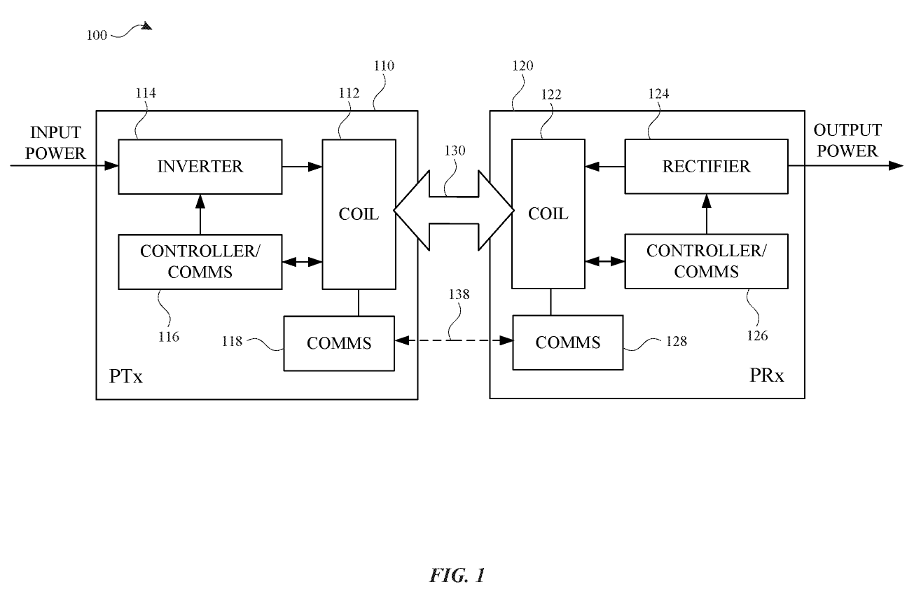

FIG. 1 illustrates a simplified block diagram of a wireless power transfer system 100. Wireless power transfer system includes a power transmitter (PTx) 110 that transfers power to a power receiver (PRx) 120 wirelessly, such as via inductive coupling 130. Power transmitter 110 may receive input power that is converted to an AC voltage having particular voltage and frequency characteristics by an inverter 114. Inverter 114 may be controlled by controller/communications circuitry 116 that operates as further described below. In various embodiments, the inverter controller and communications circuitry may be implemented in a common system, such as a system based on a microprocessor, microcontroller, or the like. In other embodiments, the inverter controller may be implemented by a separate controller circuitry and communications circuitry that have a means of communication between them. Inverter 114 may be constructed using suitable circuit topology (e.g., full bridge, half bridge, etc.) and may be implemented using suitable semiconductor switching device technology (e.g., MOSFETs, IGBTs, etc. made using silicon, silicon carbide, or gallium nitride devices).

Inverter 114 may deliver the generated AC voltage to a transfer coil 112. In addition to a wireless coil allowing magnetic coupling to the receiver, the transfer coil block 112 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transfer coil may also include a core of magnetically permeable material (e.g., ferrite) configured to affect the flux pattern of the coil in a way suitable to the particular application. The teachings herein may be applied in conjunction with any of a wide variety of transfer coil arrangements appropriate to a given application. In some contexts, transfer coil 112 may be described as a transmitting or transmitter coil. In some embodiments a device may be capable of bidirectional operation, i.e., transmitting or receiving wireless power, and thus the wireless power transfer coil of such device could be capable of transmitting or receiving power, depending on the operating mode.

PTx controller/communications circuitry 116 may monitor the transfer coil and use information derived therefrom to control the inverter 114 as appropriate for a given situation. For example, controller/communications circuitry may be configured to cause inverter 114 to operate at a given frequency or output voltage depending on the particular application. In some embodiments, the controller/communications circuitry may be configured to receive information from the PRx device and control inverter 114 accordingly. This information may be received via the power transmission coils (i.e., in-band communication) or may be received via a separate communications channel (not shown, i.e., out-of-band communication). For in-band communication, controller/communications circuitry 116 may detect and decode signals imposed on the magnetic link (such as voltage, frequency, or load variations) by the PRx to receive information and may instruct the inverter to modulate the delivered power by manipulating various parameters of the generated voltage (such as voltage, frequency, etc.) to send information to the PRx. In some embodiments, the controller/communications circuitry may be configured to employ frequency shift keying (FSK) communications, in which the frequency of the inverter signal is modulated, to communicate data to the PRx. Controller/communications circuitry 116 may be configured to detect amplitude shift keying (ASK) communications or load modulation-based communications from the PRx. In either case, controller/communications circuitry 126 may be configured to vary the current drawn on the receiver side to manipulate the waveform seen on the Tx coil to deliver information from the PRx to the PTx. For out-of-band communication, additional modules (e.g., circuitry) that allow for communication between the PTx and PRx may be provided, for example, WiFi, Bluetooth, or other radio links or any other suitable communications channel.

As mentioned above, controller/communications circuitry 116 may be a single module, for example, provided on a single integrated circuit, or may be constructed from multiple modules/devices provided on different integrated circuits or a combination of integrated and discrete circuits having analog, digital, and/or programmable components, which may be field programmable or updatable. The teachings herein are not limited to any particular arrangement of the controller/communications circuitry.

PTx device 110 may optionally include other systems and components, such as a separate communications circuitry 118. In some embodiments, communications circuitry 118 may communicate with a corresponding module or tag in the PRx via the power transfer coils. In other embodiments, communications circuitry 118 may communicate with a corresponding module using a separate physical channel 138.

As noted above, wireless power transfer system also includes a wireless power receiver (PRx) 120. Wireless power receiver can include a transfer coil 122 that may be magnetically coupled 130 to the transfer coil 112. As with transfer coil 112 discussed above, transfer coil block 122 illustrated in FIG. 1 may include tuning circuitry, such as additional inductors and capacitors, that facilitate operation of the transmitter in different conditions, such as different degrees of magnetic coupling to the receiver, different operating frequencies, etc. The wireless coil itself may be constructed in a variety of different ways. In some embodiments, the wireless coil may be formed as a winding of wire around a suitable bobbin. In other embodiments, the wireless coil may be formed as traces on a printed circuit board. Other arrangements are also possible and may be used in conjunction with the various embodiments described herein. The wireless transfer coil may also include a core of magnetically permeable material (e.g., ferrite) configured to affect the flux pattern of the coil in a way suitable to the particular application. The teachings herein may be applied in conjunction with any of a wide variety of transfer coil arrangements appropriate to a given application. In some contexts, transfer coil 122 may be described as a receiving or receiver coil. In some embodiments a device may be capable of bidirectional operation, i.e., transmitting or receiving wireless power, and thus the wireless power transfer coil of such device could be capable of transmitting or receiving power, depending on the operating mode.

Transfer coil 122 outputs an AC voltage induced therein by magnetic induction via transfer coil 112. This output AC voltage may be provided to a rectifier 124 that provides a DC output power to one or more loads associated with the PRx device. Rectifier 124 may be controlled by controller/communications circuitry 126 that operates as further described below. In various embodiments, the rectifier controller and communications circuitry may be implemented in a common system, such as a system based on a microprocessor, microcontroller, or the like. In other embodiments, the rectifier controller may be implemented by a separate controller module and communications module that have a means of communication between them. Rectifier 124 may be constructed using suitable circuit topology (e.g., full bridge, half bridge, etc.) and may be implemented using suitable semiconductor switching device technology (e.g., MOSFETs, IGBTs, etc. made using silicon, silicon carbide, or gallium nitride devices).

PRx controller/communications circuitry 126 may monitor the transfer coil and use information derived therefrom to control the rectifier 124 as appropriate for a given situation. For example, controller/communications circuitry may be configured to cause rectifier 124 to provide a given output voltage depending on the particular application. In some embodiments, the controller/communications circuitry may be configured to send information to the PTx device to effectively control the power delivered to the receiver. This information may be received sent via the power transmission coils (i.e., in-band communication) or may be sent via a separate communications channel (not shown, i.e., out-of-band communication). For in-band communication, controller/communications circuitry 126 may, for example, modulate load current or other electrical parameters of the received power to send information to the PTx. In some embodiments, controller/communications circuitry 126 may be configured to detect and decode signals imposed on the magnetic link (such as voltage, frequency, or load variations) by the PTx to receive information from the PTx. In some embodiments, controller/communications circuitry 126 may be configured to receive frequency shift keying (FSK) communications, in which the frequency of the inverter signal has been modulated to communicate data to the PRx. Controller/communications circuitry 126 may be configured to generate amplitude shift keying (ASK) communications or load modulation-based communications from the PRx. In either case, the controller/communications circuitry 126 may be configured to vary the current drawn on the receiver side to manipulate the waveform seen on the Tx coil to deliver information from the PRx to the PTx. For out-of-band communication, additional modules (e.g., circuitry) that allow for communication between the PTx and PRx may be provided, for example, WiFi, Bluetooth, or other radio links or any other suitable communications channel.

As mentioned above, controller/communications circuitry 126 may be a single module, for example, provided on a single integrated circuit, or may be constructed from multiple modules/devices provided on different integrated circuits or a combination of integrated and discrete circuits having analog, digital, and/or programmable components, which may be field programmable or updatable. The teachings herein are not limited to any particular arrangement of the controller/communications circuitry. PRx device 120 may optionally include other systems and components, such as communications circuitry 128. In some embodiments, communications circuitry 128 may communicate with a corresponding module in the PTx via the power transfer coils. In some embodiments, communications circuitry 128 may communicate with a corresponding module or tag using a separate physical channel 138.

Numerous variations and enhancements of the above-described wireless power transfer system 100 are possible, and the following teachings are applicable to any of such variations and enhancements.

As new techniques are developed and implemented for use in wireless power transfers between devices, devices that incorporate the new techniques greatly benefit from the faster and more efficient power transfer techniques. However, some new techniques cannot be used with legacy devices that were produced or put into use before the new techniques were developed or with devices that do not have the appropriate software and/or hardware to accommodate the new techniques. By incorporating functionality to accommodate such legacy devices, the new techniques and systems can seamlessly integrate into new devices while preserving backward compatibility with legacy devices. Accordingly, users can continue to use their existing legacy devices in conjunction with newer devices, while still benefiting from the advantages of the new techniques in new devices when using the new devices in conjunction with other devices that also implement the new techniques.

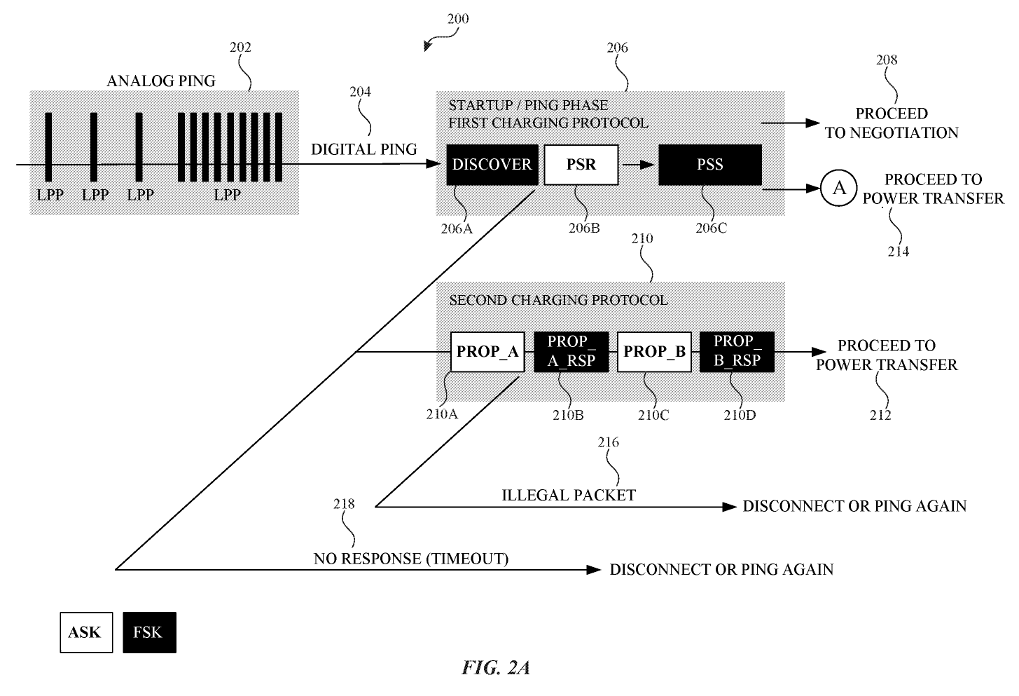

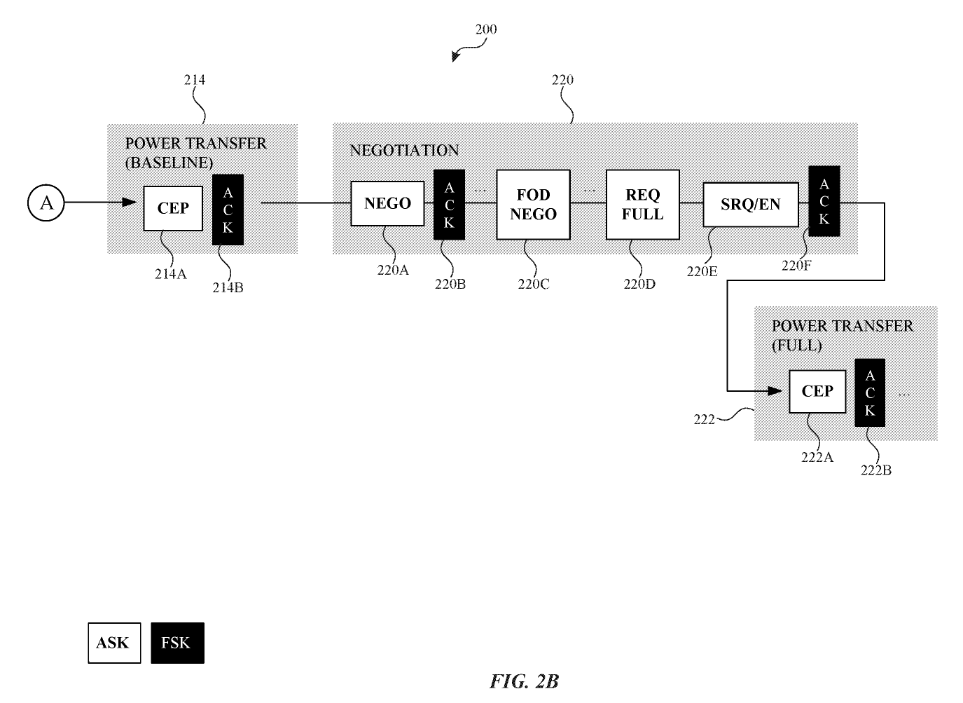

FIGS. 2A-2B illustrate example interactions 200 between a PTx and a PRx. Initially, the PTx (e.g., 110) is an idle state (e.g., at 202) and transmits analog pings to detect the presence of nearby objects that can potentially receive power. For example, the controller/communications circuitry (e.g., 116) of the PTx applies periodic test pulses to the transfer coil (e.g., 112) to check for a potential PRx (e.g., 120). Once an object, which may be a compatible PRx, is detected, the PTx transitions to transmitting a digital ping (e.g., 204), which is a higher-energy pulse as compared to the analog ping. Under some operating conditions, such as dead battery conditions, the digital ping itself provides sufficient power to power up controller/communications circuitry (e.g., 126) of the PRx, thereby enabling the PRx to communicate with the PTx.

During digital ping and beyond, a number of communications can be exchanged between the PTx and the PRx. In the illustrated example, communications sent from the PTx to the PRx are denoted with black background boxes and may use frequency shift keying (FSK) communications. Communications sent from the PRx to the PTx are denoted with white background boxes and may use amplitude shift keying (ASK) communications. Prior to receiving communications (e.g., encoded using ASK) from the PRx, the PTx transmits (e.g., via FSK) startup message 206A to the PRx during a startup procedure (e.g., 206). In some embodiments, the startup procedure involving message 206A is part of the digital ping. In some examples, startup message 206A is a pattern of eight “1” bits (e.g., 11111111). In some examples, startup message 206A is a pattern of four “1” bits alternating with four “0” bits (e.g., 10101010) or a different pattern. By transmitting startup message 206A, the PTx indicates that the PTx supports (e.g., advertises support for) a particular technique or wireless charging protocol, such as a first charging protocol. In some embodiments, startup message 206A is referred to as a discover message. For example, the PTx transmits (e.g., via FSK) the discover message during a startup procedure to advertise that the PTx supports the first charging protocol.

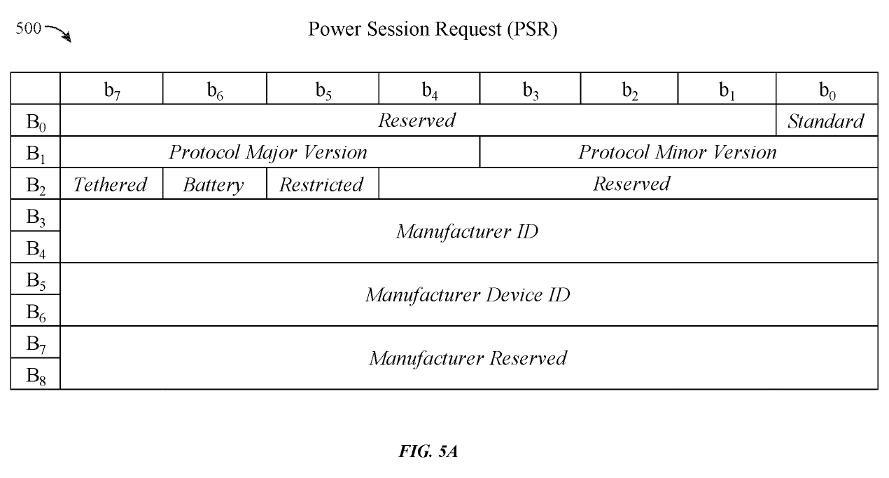

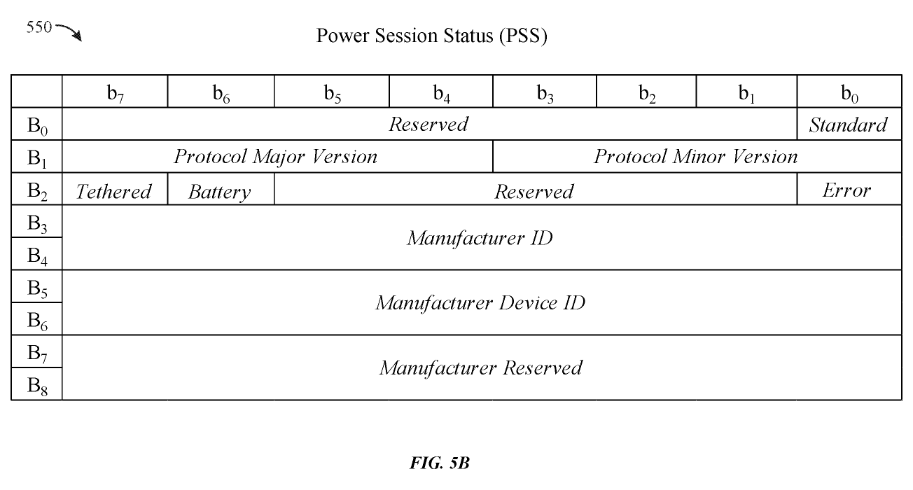

For PRx devices that support the first charging protocol, the PRx is monitoring for startup message 206A, which is also referred to as the discover message. Thus, a PRx device that supports the first charging protocol is monitoring for the discover message (e.g., is monitoring for the FSK pattern of eight “1” bits) during startup procedure 206. In response to receiving startup message 206A, a PRx that supports the first charging protocol transmits (e.g., via ASK using transfer coil 122) a message to the PTx that is in response to startup message 206A (e.g., that includes content that is based on having received startup message 206A). For example, the PRx uses controller/communications circuitry 126 and/or transfer coil 122 to transmit first type of message 206B to the PTx to indicate that the PRx supports the first charging protocol. In some embodiments, the first type of message is a power session request (PSR) message, also referred to as a “HELLO” message. In some embodiments, first type of message 206B includes one or more of (e.g., less than all or all of): a protocol version (e.g., 1 byte), a manufacturer code (e.g., 2 bytes), a device family (e.g., 1 byte), a device identifier (e.g., 2 bytes), proprietary data (e.g., 1 byte), and feature bits (e.g., 1 byte), which correspond to, identify, and/or describe capabilities of the PRx. In some examples, the feature bits identify features that are supported and/or unsupported by the PRx, such as whether the PRx has a battery and/or is tethered. In some examples, the feature bits identify one or more requests (e.g., in addition to identifying features the PRx supports), such as a request to negotiate a power transfer (e.g., negotiate the wattage and/or other details of a power transfer). An example of the first type of message is illustrated in FIG. 5A as PSR message 500.

Based on the PTx receiving (e.g., via ASK, using the controller/communications circuitry (e.g., 116), and/or using the transfer coil (e.g., 112)) first type of message 206B from the PRx (e.g., when the PTx receives first type of message 206B from the PRx), the PTx recognizes that the PRx supports the first charging protocol. In response to receiving first type of message 206B that is responsive to startup message 206A, the PTx transmits (e.g., via FSK and/or as part of the digital ping) second startup message 206C to the PRx. For example, the PTx transmits the second startup message via FSK using the controller/communications circuitry (e.g., 116) and/or using the transfer coil (e.g., 112). In some embodiments, the second startup message is a power session status (PSS) message, also referred to as a “HELLO_RSP” response message. In some embodiments, the second startup message 206C includes one or more of (e.g., less than all or all of): a protocol version (e.g., 1 byte), a manufacturer code (e.g., 2 bytes), a device family (e.g., 1 byte), a device identifier (e.g., 2 bytes), proprietary data (e.g., 1 byte), and feature bits (e.g., 1 byte), which correspond to, identify, and/or describe capabilities of the PTx. In some examples, the feature bits identify features that are supported and/or unsupported by the PTx, such as whether the PTx has a battery and/or is tethered. In some examples, the feature bits identify one or more requirements of the PTx (e.g., in addition to identifying features that the PTx supports), such as a reping requirement. An example of the second startup message is illustrated in FIG. 5B as PSS message 550.

In some embodiments, in accordance with (e.g., in response to) the PTx receiving the first type of message from the PRx (and, optionally, subsequent to the PTx transmitting second startup message 206C to the PRx), the PTx and PRx proceed to negotiate (e.g., 208) a power transfer using the first charging protocol. In some embodiments, in accordance with (e.g., in response to) the PTx receiving the first type of message from the PRx that includes a request to negotiate a power transfer (and, optionally, subsequent to the PTx transmitting the second startup message), the PTx and PRx proceed to negotiate (e.g., 208) power transfer using the first charging protocol. In some embodiments, the PRx can request to negotiate a power transfer during the digital ping phase (e.g., 206) by including the request to negotiate in first type of message 206B (e.g., the “PSR” message) transmitted to the PTx. Subsequent to negotiating power transfer (e.g., 208) using the first charging protocol, the PTx provides power transfer (e.g., via transfer coil 112) to the PRx (e.g., via transfer coil 122) based on the negotiated power transfer using the first charging protocol.

For PRx devices that do not support the first charging protocol, the PRx is not monitoring for startup message 206A during the startup procedure. For example, the PTx transmits startup message 206A to the PRx, but the PRx does not receive and/or process the message. Even if an unsupported PRx is monitoring for inbound messages generally during the startup procedure and receives or processes startup message 206A, the unsupported PRx would not recognize the particular meaning of startup message 206A. The PRx that does not support the first charging protocol transmits (e.g., via ASK) a message to the PTx that is not in response to startup message 206A (e.g., that does not include content that is based on having received startup message 206A). For example, the PRx uses controller/communications circuitry 126 and/or transfer coil 122 to transmit second type of message 210A, which is different from first type of message 206B, to the PTx. In some embodiments, second type of message 210A is not a valid first type of message. In some embodiments, second type of message 210A has a different length and/or structure as compared to first type of message 206B. In some embodiments, second type of message 210A is a proprietary message, such as a “PROP_A” message. Based on the PTx receiving second type of message 210A, the PTx and PRx proceed to use a second charging protocol that is different from the first charging protocol. For example, based on the PTx receiving second type of message 210A, the PTx and PRx proceed to negotiate (e.g., 210) power transfer using a second charging protocol that is different from the first charging protocol. For example, the PTx transmits, using controller/communications circuitry 116 and/or transfer coil 112, to the PRx acknowledgement message 210B that acknowledges receipt of second type of message 210A. In some embodiments, the PRx subsequently transmits, using controller/communications circuitry 126 and/or transfer coil 122, to the PTx a further message (e.g., 210C and/or a “PROP_B” message), which is received by the PTx, using controller/communications circuitry 116 and/or transfer coil 112. In some embodiments, the PTx transmits, using controller/communications circuitry 116 and/or transfer coil 112, to the PRx acknowledgement message 210D that acknowledges receipt of the further message (e.g., 210C). Subsequent to negotiating power transfer using the second charging protocol, the PTx provides (e.g., via transfer coil 112) power transfer (e.g., 212) to the PRx (e.g., via transfer coil 122) based on the negotiated power transfer using the second charging protocol. In some embodiments, the power transfer from the PTx to the PRx (e.g., when performed based on the negotiated power transfer using the second charging protocol) is performed at a first power level (e.g., 5 watts or 10 watts) (e.g., uses a first power profile).

In some embodiments, in accordance with the PTx receiving a third type of message (e.g., an invalid message, invalid packet, and/or an illegal packet 216), rather than first type of message 206B and second type of message 210A, the PTx forgoes negotiating power transfer and forgoes providing power transfer (e.g., via transfer coil 112) to the PRx. In some embodiments, in accordance with the PTx receiving a third type of message (e.g., an invalid message, invalid packet, and/or an illegal packet 216) from the PRx, the PTx transmits another startup message (e.g., 206A) as part of a digital ping (e.g., via transfer coil 112). In some embodiments, in accordance with the PTx not receiving any message (e.g., not receiving any valid message encoded via ASK or otherwise not responding (e.g., 218)) within a timeout duration (e.g., 1 second, 3 seconds, or 5 seconds), the PTx forgoes negotiating power transfer and forgoes providing power transfer (e.g., via transfer coil 112) to the PRx. In some embodiments, in accordance with the PTx not receiving any message (e.g., not receiving any valid message encoded via ASK or otherwise not responding (e.g., 218)) within a timeout duration (e.g., 1 second, 3 seconds, or 5 seconds), the PTx transmits another startup message (e.g., 206A) as part of a digital ping (e.g., via transfer coil 112) to the PRx.

In some embodiments, in accordance with (e.g., in response to) the PTx receiving first type of message 206B from the PRx (and, optionally, subsequent to the PTx transmitting second startup message 206C), the PTx proceeds to transfer (e.g., via transfer coil 112) power to the PRx, such as by using the first charging protocol. In some embodiments, in accordance with (e.g., in response to) the PTx receiving first type of message 206B from the PRx that does not include a request to negotiate a power transfer and/or that includes a request for power transfer without further negotiating the power transfer (and, optionally, subsequent to the PTx transmitting second startup message 206C to the PRx), the PTx proceeds to transfer power (e.g., 214) to the PRx, such as by using the first charging protocol. In some embodiments, the PTx proceeds to transfer power (e.g., 214) to the PRx without requiring additional power transfer negotiation. In some embodiments, the power transfer (e.g., 214) from the PTx to the PRx (e.g., when performed without requiring additional power transfer negotiation) is performed at a second power level (e.g., 5 watts, 10 watts, or 15 watts, using a restricted mode of the Magnetic Power Profile, and/or that uses a second power profile, such a baseline power profile) that includes more power than the first power level. The Magnetic Power Profile (“MPP”) is part of the Qi2 standard promulgated by the Wireless Power Consortium standards organization (“WPC”). An example of a baseline power profile is the Baseline Power Profile (“BPP”) that is part of the Qi standard promulgated by the WPC.

In some embodiments, during the power transfer (e.g., 214) that is performed at the second power level, the PRx optionally transmits a control error packet (CEP) (e.g., 214A) to the PTx, thereby requesting a change in power transfer. In response to receiving the CEP, the PTx acknowledges receiving the CEP by transmitting an ACK message (e.g., 214B) to the PRx and adjusts the power output based on the received CEP.

In some embodiments, subsequent to the power transfer (e.g., 214) that is performed at the second power level, the PTx and PRx negotiate power transfer (e.g., 220). For example, the PRx transmits a request (e.g., 220A) to the PTx to negotiate power transfer, which the PTx acknowledges by transmitting an ACK message (e.g., 220B) to the PRx. During the power transfer negotiation (e.g., 220), the PRx optionally transmits additional information to the PTx, such as information (e.g., 220C) for use in foreign object detection determinations (e.g., information that helps the PTx determine whether a foreign object is present), a request (e.g., 220D) for higher power during power transfer (e.g., using Full Mode of the Magnetic Power Profile), and/or a request (e.g., 220E) to end power transfer negotiation, each of which the PTx optionally acknowledges by transmitting an ACK message (e.g., 220F) to the PRx.

In some embodiments, subsequent to (e.g., in response to) the PTx and PRx negotiating power transfer (e.g., 220), the PTx provides (e.g., via transfer coil 112) power transfer (e.g., 222) to the PRx (e.g., via transfer coil 122) based on the negotiated power transfer (e.g., at Full Mode, such as at 15W, 25W, or 50W). During the power transfer (e.g., 222) based on the negotiated power transfer, the PRx optionally transmits a control error packet (CEP) (e.g., 222A) to the PTx, thereby requesting a change in power output. In response to receiving the CEP, the PTx acknowledges receiving the CEP by transmitting an ACK message (e.g., 222B) to the PRx and adjusts the power output based on the received CEP.

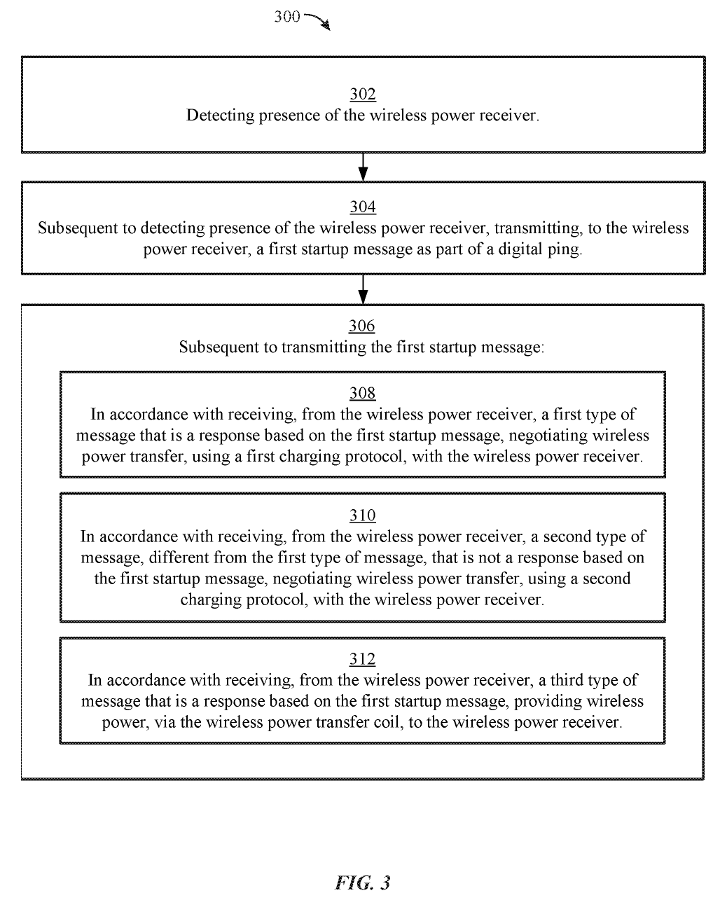

FIG. 3 is a flow diagram illustrating example processes for interactions between wireless power systems, in accordance with some embodiments. In some embodiments, process (300) is performed by a wireless power transmitter (e.g., 110) that comprises a wireless power transfer coil (e.g., 112, that is configured to wirelessly transfer power to a wireless power receiver), an inverter (e.g., 114) configured to receive input power (e.g., via DC voltage) and to generate an output (e.g., with AC voltage) to the wireless power transfer coil (e.g., 112) to wirelessly deliver power (e.g., via inductive coupling 130) to a wireless power receiver (e.g., 120, using a wireless power transfer coil 122), and a controller (e.g., 116) coupled to the inverter (e.g., 114) and to the wireless power transfer coil (e.g., 112) that controls the inverter (e.g., 114) to regulate wireless power transfer to the wireless power receiver (e.g., 120). In some embodiments, instructions for performing the processes are stored on a (e.g., transitory and/or non-transitory) computer-readable storage medium and one or more processors are configured to access the instructions and perform the processes. In some embodiments, the processes are performed by the controller (e.g., 116). In some embodiments, the controller (e.g., 116) includes communication circuitry for communicating with a wireless power receiver (e.g., 120).

The wireless power transmitter detects (302) (e.g., via an analog ping, such as in 202) presence of the wireless power receiver. Subsequent to (e.g., in response to) detecting presence of the wireless power receiver, the wireless power transmitter transmits(304), to the wireless power receiver, a first startup message (e.g., a discover message, 206A, and/or a pattern, such as an FSK pattern of “1” bits for a defined duration of time, such as eight “1” bits) as part of a digital ping (e.g., 204, such as by using the wireless power transfer coil). Subsequent to (306) transmitting the first startup message and in accordance with receiving, from the wireless power receiver, a first type of message (e.g., a PSR message and/or a “HELLO” message 206B) that is a response based on (e.g., that acknowledges) the first startup message, the wireless power transmitter negotiates (308) wireless power transfer (e.g., 208), using a first charging protocol, (e.g., without negotiating a power transfer using a second charging protocol) with the wireless power receiver. Subsequent to (306) transmitting the first startup message and in accordance with receiving, from the wireless power receiver, a second type of message (e.g., a PROP_A message 210A, an identifier that specifies the type of charging system of the wireless power receiver, and/or an identifier that corresponds to charging protocols and/or features supported by the wireless power receiver), different from the first type of message, that is not a response based on (e.g., is not acknowledging) the first startup message, the wireless power transmitter negotiates (310) wireless power transfer (e.g., at 210), using a second charging protocol, with the wireless power receiver (e.g., without negotiating a power transfer using the first charging protocol).

In some embodiments, the first charging protocol is part of a first standard (and, optionally, not part of the second standard) and the second charging protocol is part of a second standard (and, optionally, not part of the first standard), and wherein the first standard and the second standard are different wireless charging standards and/or different versions of a same wireless charging standard. For example, the first charging protocol is defined by the Qi charging standard, and the second charging protocol is defined by the AirFuel Alliance. As another example, the first charging protocol is defined by the Qi charging standard, and the second charging protocol is a proprietary protocol defined by the manufacturer of electronic devices 110 and/or 120.

In some embodiments, the first charging protocol and the second charging protocol are part of a same wireless charging standard. In some embodiments, the first charging protocol supports (e.g., accommodates and/or can achieve a maximum of) a first power transfer level (e.g., a first wattage level) and the second charging protocol supports (e.g., accommodates and/or can achieve a maximum of) a second power transfer level (e.g., a second wattage level) that is different from the first power transfer level. For example, the first charging protocol is a protocol defined in Qi2, supporting 15W wireless charging and above, while the second charging protocol is a protocol defined in Qi version 1, supporting 5W wireless charging.

In some embodiments, the first charging protocol (e.g., Qi standard, a revision of a Qi standard, and/or a Qi-based standard) is part of a standard (e.g., is standardized by a standards-setting organization) and the second charging protocol is a proprietary protocol (e.g., a non-standardized charging protocol and/or a protocol developed and controlled by a specific manufacturer).

In some embodiments, negotiating wireless power, using the first charging protocol, with the wireless power receiver comprises: transmitting (e.g., using the wireless power transfer coil), to the wireless power receiver, a second startup message (e.g., a PSS message and/or “HELLO_RSP” response message 206C) as part of the digital ping (e.g., that completes the digital ping handshake), wherein the second startup message is a response based on (e.g., that acknowledges and or provides information requested by) the received first type of message.

In some embodiments, the wireless power transfer coil provides wireless power to the wireless power receiver at an initial power transfer level (e.g., at 206) before the second startup message is transmitted.

In some embodiments, the second startup message (e.g., PSS 550, described with respect to FIG. 5B) includes an error status (e.g., an error bit) indicating whether the wireless power transmitter and the wireless power receiver support a compatible charging standard. For example, a value of 0 for the error bit indicates that the wireless power transmitter accepts the current charging session and a value of 1 for the error bit indicates that the wireless power transmitter rejects the current charging session. For example, the wireless power transmitter may reject the charging session due to incompatible standards supported by the wireless power transmitter and the wireless power receiver.

In some embodiments, the second startup message (e.g., PSS 550, described with respect to FIG. 5B) includes an indication of a supported charging standard. For example, a value of 0 for the standard bit indicates that the wireless power transmitter supports the first charging protocol.

In some embodiments, the initial power transfer level (e.g., 5 watts or 10 watts) is less than a first power transfer level (e.g., a first wattage level) that the first charging protocol (or, optionally, that the wireless power transmitter) supports (e.g., accommodates and/or can achieve a maximum of).

In some embodiments, the wireless power transfer coil provides wireless power to the wireless power receiver at a negotiated power transfer level that is higher than the initial power transfer level (e.g., 15 watts, 25 watts, or more) after (e.g., as a result of and/or after completing) negotiating wireless power transfer (e.g., at 208).

In some embodiments, subsequent to (306) transmitting the first startup message and in accordance with receiving, from the wireless power receiver, a third type of message (e.g., 206B, a “HELLO” message that does not include a request to negotiate power transfer and/or a “HELLO” message that requests power transfer without power transfer negotiation) that is a response based on (e.g., that acknowledges) the first startup message, the wireless power transmitter provides (312) wireless power (e.g., at 214, using the first charging protocol), via the wireless power transfer coil, to the wireless power receiver (e.g., without negotiating a power transfer using a second charging protocol). In some embodiments, the first type of message and the third type of message have the same message structure and/or length. In some embodiments, the first type of message includes a request to negotiate power transfer and the second type of message does not include a request to negotiate power transfer. In some embodiments, the second type of message includes a request for power transfer without negotiating power transfer and the first type of message does not include a request for power transfer without negotiating power transfer.

Note that details described above with respect to process 300 are also optionally applicable in an analogous manner to the processes described below. For example, process 300 optionally includes one or more of the characteristics of the various processes described below with reference to process 400. For example, the wireless power transmitter is the same wireless power transmitter. For another example, the first type of message is optionally the same type of message in both processes. For another example, the second type of message is optionally the same type of message in both processes.

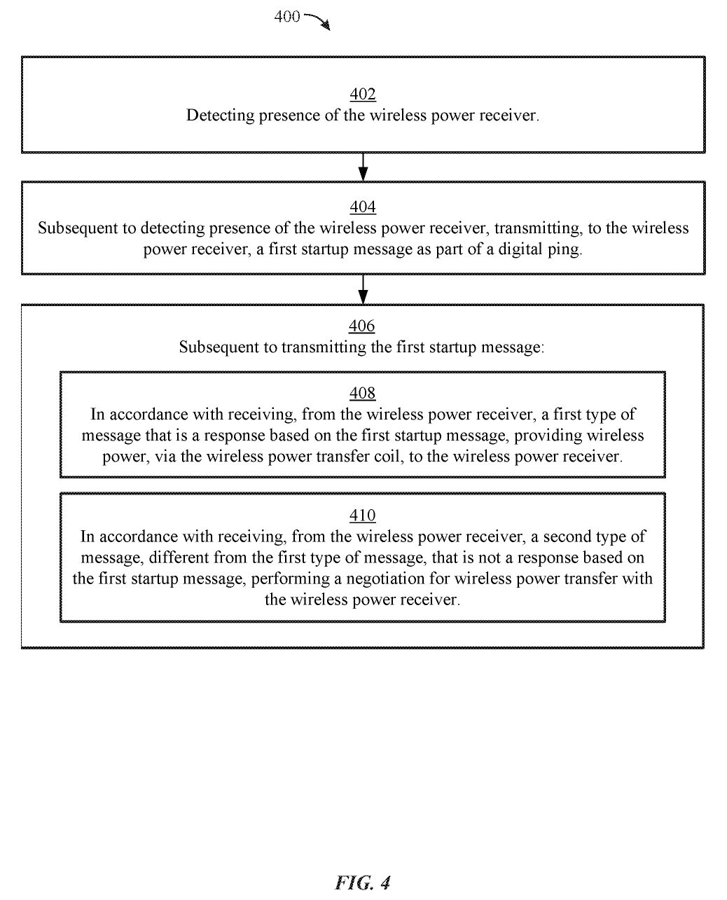

FIG. 4 is a flow diagram illustrating example processes for interactions between wireless power systems, in accordance with some embodiments. In some embodiments, process 400 is performed by a wireless power transmitter (e.g., 110) that comprises a wireless power transfer coil (e.g., 112, that is configured to wirelessly transfer power to a wireless power receiver), an inverter (e.g., 114) configured to receive input power (e.g., via DC voltage) and to generate an output (e.g., with AC voltage) to the wireless power transfer coil (e.g., 112) to wirelessly deliver power to a wireless power receiver (e.g., 120, using a wireless power transfer coil 122), and a controller (e.g., 116) coupled to the inverter (e.g., 114) and to the wireless power transfer coil (e.g., 112) that controls the inverter (e.g., 114) to regulate wireless power transfer to the wireless power receiver (e.g., 120). In some embodiments, instructions for performing the processes are stored on a (e.g., transitory and/or non-transitory) computer-readable storage medium and one or more processors are configured to access the instructions and perform the processes. In some embodiments, the processes are performed by the controller (e.g., 116). In some embodiments, the controller (e.g., 116) includes communication circuitry for communicating with a wireless power receiver (e.g., 120).

The wireless power transmitter detects (402) (e.g., via an analog ping, such as 202) presence of the wireless power receiver. Subsequent to (e.g., in response to) detecting presence of the wireless power receiver, the wireless power transmitter transmits (404), to the wireless power receiver, a first startup message (e.g., a discover message, 206A, and/or a pattern, such as an FSK pattern of “1” bits for a defined duration of time, such as eight “1” bits) as part of a digital ping (e.g., 204, such as by using the wireless power transfer coil). Subsequent to (406) transmitting the first startup message and in accordance with (e.g., in response to) receiving, from the wireless power receiver, a first type of message (e.g., a PSR message and/or a “HELLO” message 206B) that is a response based on (e.g., that acknowledges) the first startup message, the wireless power transmitter provides (408) wireless power (e.g., 214), via the wireless power transfer coil, to the wireless power receiver. Subsequent to (406) transmitting the first startup message and in accordance with (e.g., in response to) receiving, from the wireless power receiver, a second type of message (e.g., a PROP_A message 210A, an identifier that specifies the type of charging system of the wireless power receiver, and/or an identifier that corresponds to charging protocols and/or features supported by the wireless power receiver), different from the first type of message, that is not a response based on (e.g., is not acknowledging) the first startup message, the wireless power transmitter performs (410) a negotiation (e.g., at 210) for wireless power transfer with the wireless power receiver (e.g., prior to providing wireless power, via the wireless power transfer coil, to the wireless power receiver).

In some embodiments, providing wireless power to the wireless power receiver in accordance with receiving the first type of message (e.g., 206B) comprises providing wireless power (e.g., at 214) to the wireless power receiver at an initial power transfer level (e.g., 5 watts or 10 watts) that is less than a first power transfer level (e.g., a first wattage level) that the wireless power transmitter supports (e.g., accommodates and/or can achieve a maximum of).

In some embodiments, subsequent to providing wireless power to the wireless power receiver in accordance with receiving the first type of message, the wireless power transmitter negotiates (e.g., an initial negotiation or a further negotiation, such as at ), with the wireless power receiver, wireless power transfer (e.g., 220, using a charging protocol) for a negotiated power transfer level (e.g., 15 watts, 25 watts, or more) that is higher than the initial power transfer level. In some embodiments, after (e.g., as a result of and/or after completing) negotiating wireless power transfer for the negotiated power transfer level, the wireless power transmitter provides wireless power (e.g., at 222), via the wireless power transfer coil, to the wireless power receiver at the negotiated power transfer level that is higher than the initial power transfer level.

In some embodiments, negotiating wireless power transfer (e.g., at 220) for the negotiated power transfer level that is higher than the initial power transfer level includes performing (e.g., by the wireless power transmitter) foreign object detection (e.g., by detecting the presence of unexpected metal objects in the wireless charging path).

In some embodiments, providing wireless power to the wireless power receiver in accordance with receiving the first type of message (e.g., 206B) comprises providing wireless power to the wireless power receiver (e.g., at 214) without performing the negotiation (e.g., at 210 and/or at 208) for wireless power transfer with the wireless power receiver. In some embodiments, in accordance with receiving, from the wireless power receiver, the first type of message, the wireless power transmitter provides wireless power without needing to perform (and without performing) the type of negotiation that is otherwise performed in accordance with receiving the second type of message.

Note that details described above with respect to process 400 are also optionally applicable in an analogous manner to the processes described above. For example, process 400 optionally includes one or more of the characteristics of the various processes described above with reference to process 300. For example, the wireless power transmitter is the same wireless power transmitter. For another example, the first type of message is optionally the same type of message in both processes. For another example, the second type of message is optionally the same type of message in both processes.

FIGS. 5A-5B illustrate example PSR and PSS messages, respectively. At FIG. 5A, PSR message 500 includes one or more of (e.g., less than all or all of): information about a standard that the PRx supports, a supported protocol version, whether the PRx is tethered, whether the PRx contains a battery, whether the PRx intends to enter a negotiation phase after the PSR/PSS messages or to enter a restricted mode after the PSR/PSS messages, and information about the PRx manufacturer. A value of 0 for the standard bit indicates that the PRx supports the first charging protocol, described with respect to 206. In some embodiments, a value of 1 for the standard bit indicates that the PRx supports a different charging protocol, such as a Qi-based charging protocol that is different from the first charging protocol. A value of 0 for the tether bit indicates that the PRx is not tethered to a mains power source and a value of 1 for the tether bit indicates that the PRx is tethered to a mains power source. A value of 0 for the battery bit indicates that the PRx does not contain a battery and a value of 1 for the battery bit indicates that the PRx does contain a battery. A value of 0 for the restricted bit indicates that the PRx intends to enter a negotiation phase (e.g., 208 at FIG. 2A) after the PSR/PSS messages and a value of 1 for the restricted bit indicates that the PRx intends to enter a restricted mode (e.g., 214 at FIG. 2A) after the PSR/PSS messages. For example, when a PRx wants a standard or default charging rate, the PRx can specify a value of 1 for the restricted bit. When a PRx wants a higher charging rate than the standard or default charging rate, the PRx can specify a value of 0 for the restricted bit, hereby indicating to the PTx that the PRx wants to negotiate a higher charging rate after the PSR/PSS messages. In some embodiments, PSR message 500 additionally includes a header that identifies the data communication packet as containing a PSR message, such as a header value of 0x8A.

At FIG. 5B, PSS message 550 includes one or more of (e.g., less than all or all of): information about a standard that the PTx supports, a supported protocol version, whether the PTx is tethered, whether the PTx contains a battery, an error status, and information about the PTx manufacturer. A value of 0 for the standard bit indicates that the PTx supports the first charging protocol, such as described with respect to 206. In some embodiments, a value of 1 for the standard bit indicates that the PRx supports a different charging protocol, such as a Qi-based charging protocol that is different from the first charging protocol. A value of 0 for the tether bit indicates that the PTx is not tethered to a mains power source and a value of 1 for the tether bit indicates that the PTx is tethered to a mains power source. A value of 0 for the battery bit indicates that the PTx does not contain a battery and a value of 1 for the battery bit indicates that the PTx does contain a battery. A value of 0 for the error bit indicates that the PTx accepts the current charging session and a value of 1 for the error bit indicates that the PTx rejects the current charging session due to, for example, incompatible standards supported by the PTx and PRx. In some embodiments, PSS message 550 additionally includes a header that identifies the data communication packet as containing a PSS message, such as a header value of 0x8A. It is noted that, although the example of FIG. 5B shows each of the above-referenced fields as having a length of 1 bit, other field lengths can be utilized as appropriate to support the transmission additional values for the respective field. For example, a PTx that supports more than two charging protocols may wish for the standard field to span multiple bits of PSS message 550.

FIG. 6 illustrates example process 600 for communicating a PSS message. At block 602, the PTx receives a PSR message from a PRx. The PTx analyses the PSR message and, at block 604, determines whether the standard specified in the PSR that the PRx supports matches a standard supported by the PTx. In accordance with a determination that the standard specified in the PSR matches a standard supported by the PTx, the PTx continues the charging session at block 606. For example, the PTx transmits a PSS message to the PRx that has the error bit set to 0. In accordance with a determination that the standard specified in the PSR does not match a standard supported by the PTx, the PTx transmits a PSS message to the PRx that has the error bit set to 1 at block 608 and removes power. At block 610, the PTx disconnects the charging session. The PSR and PSS messages are designed to minimize data transferred at the start of a charging session, thereby increasing the efficiency of the charging process. Based on the received PSS message (e.g., the error value in the PSS message), the PRx optionally outputs (e.g., to a user) an indication that the charging session will continue or an indication that the charging session will not continue. For example, the output is an audio, tactile, and/or visual output. In some embodiments, when the error bit is set to 1, the output to the user by the PRx optionally indicates to the user that the PTx is incompatible with the PRx and/or does not support the charging standard requested by the PRx. This lets the user know that the user is attempting to charge a device (the PRx) using an incompatible charger (the PTx). It is noted that, although the example of FIG. 5B shows each of the above-referenced fields as having a length of 1 bit, other field lengths can be utilized as appropriate to support the transmission additional values for the respective field.

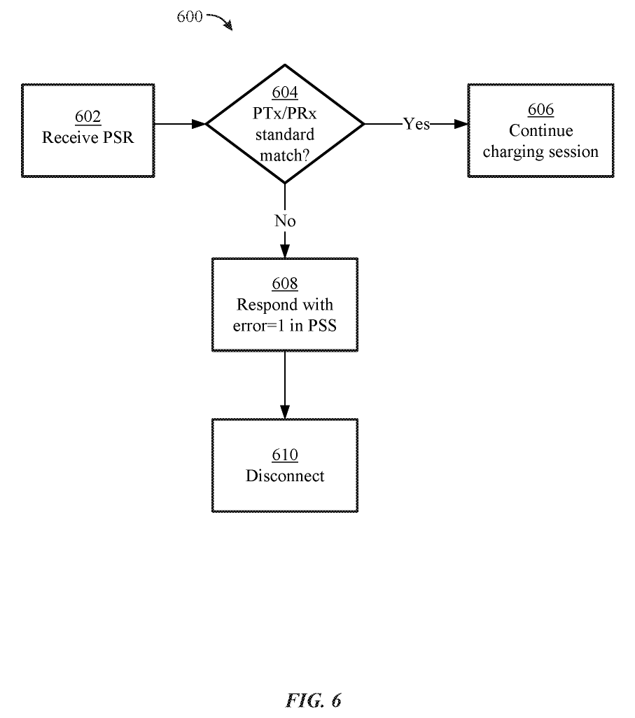

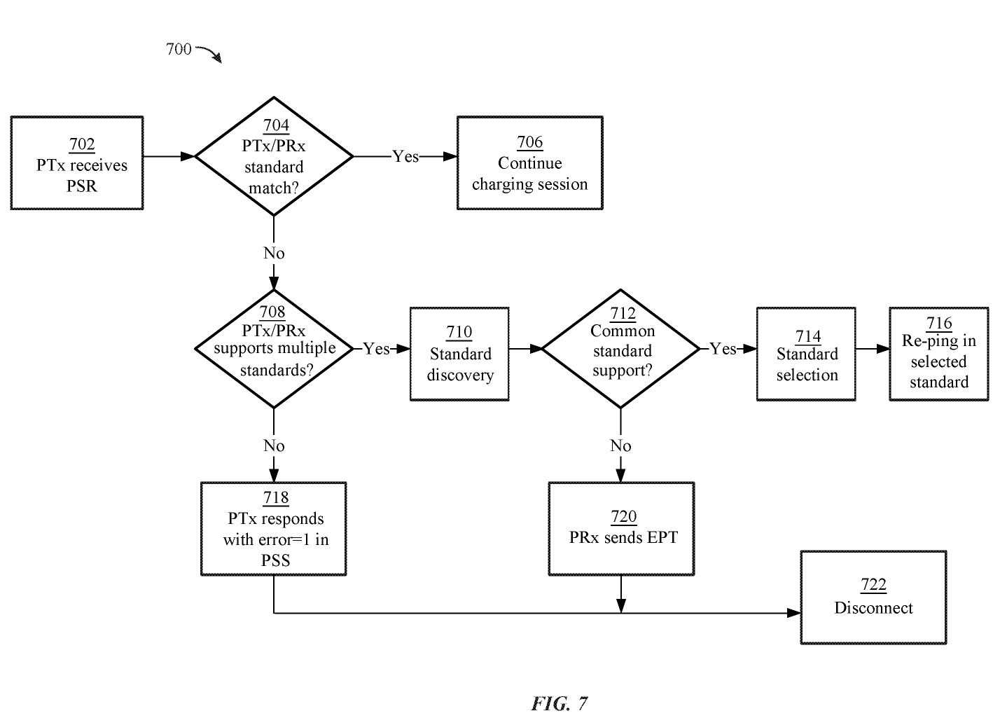

FIG. 7 illustrates example process 700 for communicating information regarding protocol selection between the PRx and PTx. For example, the information is transmitted to the PTx by the PRx as part of a PSR message (more broadly referred to as a first type of message, above). The PSR message may use a similar (or the same) PSR message structure illustrated and described above with respect to PSR message 500 in FIG. 5A. For another example, the information is transmitted to the PRx by the PTx as part of a PSS message (broadly referred to as a second startup message, above), such as by using a similar (or the same) PSS message structure illustrated and described above with respect to PSS message 550 in FIG. 5B.

The PRx uses the Standard field in PSR message 500 to identify a preferred charging protocol (e.g., a standard). For example, the Standard field may be a 1-bit field, as illustrated in FIG. 5A, or may be a multiple-bit field. The PRx sets the Standard field in the PSR message to specify the charging protocol (e.g., a wireless power transfer standard) that the PRx prefers to use (e.g., for wireless power transfer). For example, the PRx may specify a first charging protocol that is a first standard (and, optionally, not part of a second standard) in the Standard field or may specify a second charging protocol that is part of the second standard (and, optionally, not part of the first standard), where the first standard and the second standard are different wireless charging/power transfer standards and/or different versions of a same wireless charging/power transfer standard. As an example, a value of 0 for the Standard field in PSR message 500 specifies that the PRx supports and prefers to use the first charging protocol and a value of 1 for the Standard field in PSR message 500 specifies that the PRx supports and prefers to use the second charging protocol, different from the first charging protocol.

The PRx uses a Multiple Standard (MS) field in PSR message 500 to identify whether the PRx supports multiple charging protocols (e.g., standards). For example, the MS field may be a 1-bit or a multiple-bit field. The MS field may be located at one of the locations identified in PSR message 500 of FIG. 5A as reserved, such as at the bit located adjacent to the Standard field (and therefore would no longer be a reserved location). The PRx sets the value of the MS field based on whether the PRx supports multiple charging protocols (e.g., standards). As an example, a value of 0 for the MS field in PSR message 500 specifies that the PRx does not support multiple charging protocols (e.g., standards) and a value of 1 for the MS field in PSR message 500 specifies that the PRx supports multiple charging protocols (e.g., standards).

The PTx use the Standard field in PSS message 550 to identify the current operating charging protocol (e.g., the current operating standard). For example, the Standard field may be a 1-bit field, as illustrated in FIG. 5B, or may be a multiple-bit field. The PTx sets the Standard field in the PSR message to specify the current operating charging protocol (e.g., the wireless power transfer standard) that the PTx is currently using to operate (e.g., for wireless power transfer). For example, the PTx may specify the first charging protocol or may specify the second charging protocol. As an example, a value of 0 for the Standard field in PSS message 550 specifies that the PTx supports and is currently operating using the first charging protocol and a value of 1 for the Standard field in PSS message 550 specifies that the PTx supports and is currently operating using the second charging protocol, different from the first charging protocol.

The PTx uses an MS field in PSS message 550 to identify whether the PTx supports multiple charging protocols (e.g., standards). For example, the MS field may be a 1-bit or a multiple-bit field. The MS field may be located at one of the locations identified in PSS message 550 of FIG. 5B as reserved, such as at the bit located adjacent to the Standard field (and therefore would no longer be a reserved location). The PTx sets the value of the MS field based on whether the PTx supports multiple charging protocols (e.g., standards). As an example, a value of 0 for the MS field in PSS message 550 specifies that the PTx does not support multiple charging protocols (e.g., standards) and a value of 1 for the MS field in PSS message 550 specifies that the PTx supports multiple charging protocols (e.g., standards).

At block 702, the PTx receives a PSR message from a PRx (e.g., after the PTx transmits a digital ping, such as a digital ping that includes a discover message). At block 704, the PTx analyses the PSR message and determines whether the preferred charging protocol (e.g., the preferred power transfer standard) specified in the Standard field of the PSR message matches the current operating charging protocol (e.g., the current operating standard) of the PTx.

In accordance with a determination that the preferred charging protocol specified by the PRx in the Standard field of the PSR message matches the current operating charging protocol of the PTx, the PTx continues the charging session at block 706. For example, the PTx transmits a PSS message to the PRx that has the error bit set to 0 (to indicate that the PTx accepts the current charging session), along with appropriate values for the Standard and MS fields in the PSS message. In accordance with a determination that the preferred charging protocol specified by the PRx in the Standard field of the PSR message does not match the current operating charging protocol of the PTx, the PTx determines, at block 708, whether the PTx and/or the PRx support multiple protocols (e.g., standards). For example, the PTx analyses the value in the MS field of the PSS message received from the PRx to determine if the PRx supports multiple protocols.

In accordance with a determination that the PTx and/or the PRx support multiple charging protocols, the process proceeds to block 710. In accordance with a determination that neither the PTx nor the PRx supports multiple charging protocols, the process proceeds to block 718. For example, at block 718, the PTx transmits a PSS message to the PRx that has the error bit set to 1 (indicating an error), along with appropriate values for the Standard and MS fields in the PSS message, and the power transfer session disconnects at block 722.

At block 710, the PTx and/or the PRx perform standard discovery procedures, as described in additional detail below, to exchange information about the protocols (e.g., standards) that the PTx and/or the PRx support. At block 712, after performing the standard discovery procedures, the PTx and/or the PRx determines whether the PTx and PRx support a common charging protocol (e.g., a common power transfer standard).

In accordance with a determination that the PTx and the PRx support a common charging protocol, the process proceeds to block 714. In accordance with a determination that the PTx and the PRx do not support a common charging protocol, the process proceeds to block 720, whereby the PRx optionally sends an EPT message at block 720 and the power transfer session disconnects at block 722.

At block 714, the PTx and the PRx proceed to a standard selection process, during which a common charging protocol (e.g., a common power transfer standard) that is supported by both the PRx and the PTx is selected. At block 716, the PTx re-pings (e.g., after disconnecting the power transfer session) using the selected common charging protocol and, optionally, the process proceeds to block 702.

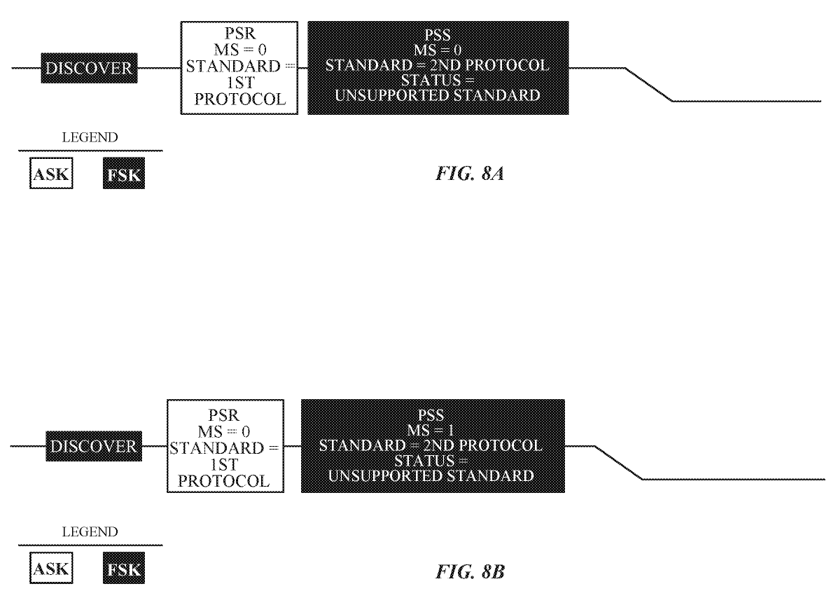

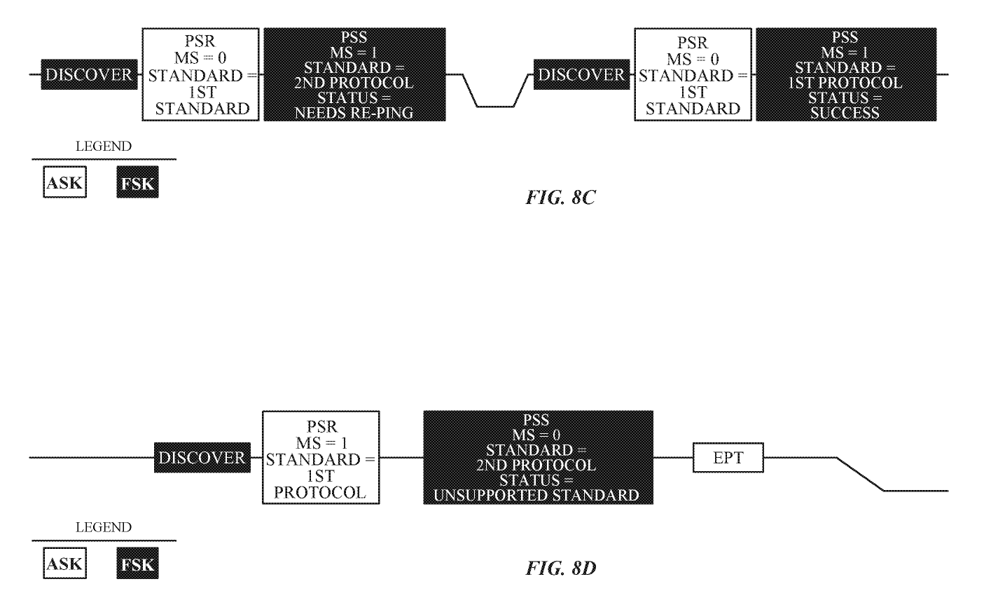

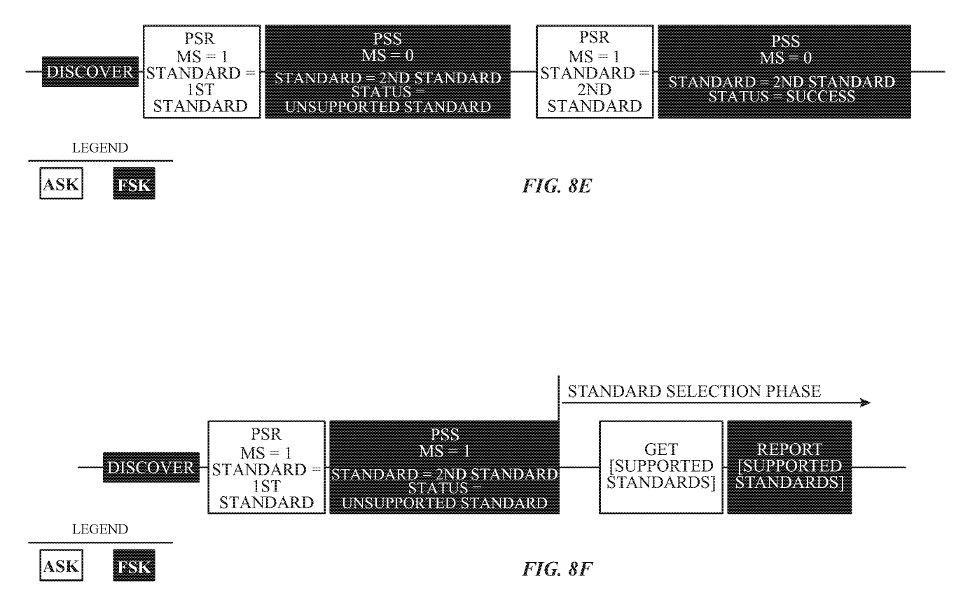

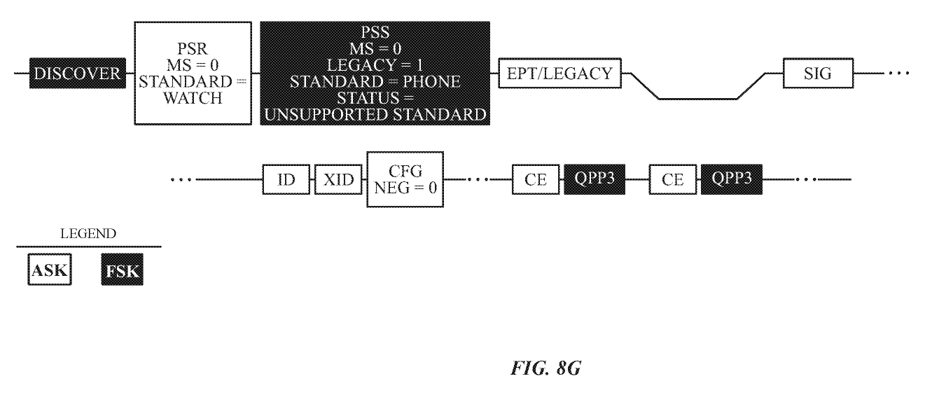

FIG. 8A illustrates a scenario where the PTx and the PRx are operating on mismatched standards and neither the PTx nor the PRx supports multiple standards (e.g., the flow that leads to block 718 and, ultimately, block 722 in FIG. 7), in accordance with some embodiments. In particular, the PTx transmits a digital ping that encodes a discover message (e.g., as described above). Subsequently (e.g., in response), the PRx transmits a PSR message, which the PTx receives. The PSR message indicates that the PRx does not support multiple standards (e.g., by setting the MS field of the PSR message to 0) and that the PRx prefers the first charging protocol (e.g., by setting the standard field of the PSR message to 0). Because the PTx is operating using the second charging protocol and also does not support multiple standards, the PTx transmits a PSS message to the PRx indicating that the PTx does not support multiple standards (e.g., by setting the MS field of the PSR message to 0), that the PTx is currently operating using the second charging protocol (e.g., by setting the standard field of the PSR message to 1), and that an error exists (e.g., by setting a status field, such as the error bit, of the PSS message to indicate that the charging protocol preferred by the PRx is not supported). In this scenario, the current power session should be rejected and power should be disconnected because there is a mismatch in the standards and neither the PTx nor the PRx supports multiple standards. After disconnecting, the PTx (e.g., based on system policy) determines when to re-ping (e.g., wait until the object removed from the PTx, wait a defined period of time, or otherwise). In some embodiments, as described with respect to FIG. 8G, the system may switch to operating in a legacy mode of operation.

FIG. 8B illustrates a scenario where the PTx and the PRx are operating on mismatched standards and the PTx supports multiple standards, but does not support the standard being used by the PRx (e.g., the flow that leads to block 712 and, ultimately, block 722 in FIG. 7). In particular, the PTx transmits a digital ping that encodes a discover message (e.g., as described above). Subsequently (e.g., in response), the PRx transmits a PSR message, which the PTx receives. The PSR message indicates that the PRx does not support multiple standards (e.g., by setting the MS field of the PSR message to 0) and that the PRx prefers the first charging protocol (e.g., by setting the standard field of the PSR message to 0). Because the PTx is operating using the second charging protocol and the PTx does not support the first charging protocol (even though the PTx supports one or more protocols in addition to the second charging protocol), the PTx transmits a PSS message to the PRx indicating that the PTx does support multiple standards (e.g., by setting the MS field of the PSS message to 1), that the PTx is currently operating using the second charging protocol (e.g., by setting the standard field of the PSS message to 1), and that an error exists (e.g., by setting a status field, such as the error bit, of the PSS message to indicate that the charging protocol preferred by the PRx is not supported). The standard discovery process (e.g., block 710) may be omitted because the PTx already knows what single standard the PRx supports and what standards the PTx supports. Similarly, block 720 is optionally omitted. In this scenario, the current power session should be rejected and power should be disconnected because there is a mismatch in the standards and the PTx and PRx do not support a common standard. After disconnecting, the PTx (e.g., based on system policy) determines when to re-ping (e.g., wait until the object removed from the PTx, wait a defined period of time, or otherwise).

FIG. 8C illustrates a scenario where the PTx and the PRx are operating on mismatched standards and the PTx supports multiple standards, including the standard being used by the PRx (e.g., the flow that leads to block 716, back to block 702, and, ultimately, to block 706 in FIG. 7). In particular, the PTx transmits a digital ping that encodes a discover message (e.g., as described above). Subsequently (e.g., in response), the PRx transmits a PSR message, which the PTx receives. The PSR message indicates that the PRx does not support multiple standards (e.g., by setting the MS field of the PSR message to 0) and that the PRx prefers the first charging protocol (e.g., by setting the standard field of the PSR message to 0). Because the PTx is operating using the second charging protocol and the PTx supports multiple protocols, including the first charging protocol, the PTx transmits a PSS message to the PRx indicating that the PTx does support multiple standards (e.g., by setting the MS field of the PSS message to 1), that the PTx is currently operating using the second charging protocol (e.g., by setting the standard field of the PSS message to 1), and that a re-ping is required (e.g., by setting a status field, such as the error bit, of the PSS message to indicate a re-ping will occur). The standard discovery process (e.g., block 710) may be omitted because the PTx already knows what single standard the PRx supports and what standards the PTx supports. In this scenario, the PTx re-pings the PRx using the common charging protocol (e.g., the first charging protocol), as shown in FIG. 8C. Because the standards match, the process proceeds towards the power transfer phase (e.g., via block 706).

FIG. 8D illustrates a scenario where the PTx and the PRx are operating on mismatched standards and the PRx supports multiple standards, but not the standard being used by the PTx (e.g., the flow that leads to block 720 and, ultimately, block 722 in FIG. 7). In particular, the PTx transmits a digital ping that encodes a discover message (e.g., as described above). Subsequently (e.g., in response), the PRx transmits a PSR message, which the PTx receives. The PSR message indicates that the PRx supports multiple standards (e.g., by setting the MS field of the PSR message to 1) and that the PRx prefers the first charging protocol (e.g., by setting the standard field of the PSR message to 0). Because the PTx is operating using the second charging protocol and the PTx does not support multiple protocols, the PTx transmits a PSS message to the PRx indicating that the PTx does not support multiple standards (e.g., by setting the MS field of the PSS message to 0), that the PTx is currently operating using the second charging protocol (e.g., by setting the standard field of the PSR message to 1), and that an error exists (e.g., by setting a status field, such as the error bit, of the PSS message to indicate that the charging protocol preferred by the PRx is not supported). The standard discovery process (e.g., block 710) may be omitted because the PRx now knows what single standard the PTx supports and what standards the PRx supports. The PTx does not end the power session to give the PRx a chance to reconcile the scenario (e.g., switch to using the second charging protocol). However, because the PRx does not support the only protocol that the PTx supports (e.g., the second charging protocol), the PRx transmits an EPT message to end the power session.

FIG. 8E illustrates a scenario where the PTx and the PRx are operating on mismatched standards and the PRx supports multiple standards, including the standard being used by the PTx (e.g., a flow that leads to block 712 and then directly back to block 702 in FIG. 7). In particular, the PTx transmits a digital ping that encodes a discover message (e.g., as described above). Subsequently (e.g., in response), the PRx transmits a PSR message, which the PTx receives. The PSR message indicates that the PRx supports multiple standards (e.g., by setting the MS field of the PSR message to 1) and that the PRx prefers the first charging protocol (e.g., by setting the standard field of the PSR message to 0). Because the PTx is operating using the second charging protocol and the PTx does not support multiple protocols, the PTx transmits a PSS message to the PRx indicating that the PTx does not support multiple standards (e.g., by setting the MS field of the PSS message to 0), that the PTx is currently operating using the second charging protocol (e.g., by setting the standard field of the PSR message to 1), and that an error exists (e.g., by setting a status field, such as the error bit, of the PSS message to indicate that the charging protocol preferred by the PRx is not supported). The standard discovery process (e.g., block 710) may be omitted because the PRx now knows what single standard the PTx supports and what standards the PRx supports. The PTx does not end the power session to give the PRx a chance to reconcile the scenario (e.g., switch to using the second charging protocol). Because the PRx does support the protocol that the PTx supports (e.g., the second charging protocol), the PRx may re-request the power session (by resending PSR) to start a power session using the second charging protocol, which both the PTx and PRx support, as shown in FIG. 8E. Because the standards match, the process proceeds towards the power transfer phase (e.g., via block 706).

FIG. 8F illustrates a scenario where the PTx and the PRx are operating on mismatched standards and both the PTx and the PRx support multiple standards (e.g., a flow that leads to block 716, back to block 702, and ultimately to block 706 in FIG. 7). In particular, the PTx transmits a digital ping that encodes a discover message (e.g., as described above). Subsequently (e.g., in response), the PRx transmits a PSR message, which the PTx receives. The PSR message indicates that the PRx supports multiple standards (e.g., by setting the MS field of the PSR message to 1) and that the PRx prefers the first charging protocol (e.g., by setting the standard field of the PSR message to 0). Because the PTx is operating using the second charging protocol and the PTx also supports multiple protocols, the PTx transmits a PSS message to the PRx indicating that the PTx supports multiple standards (e.g., by setting the MS field of the PSS message to 1), that the PTx is currently operating using the second charging protocol (e.g., by setting the standard field of the PSR message to 1), and that an error exists (e.g., by setting a status field, such as the error bit, of the PSS message to indicate that the charging protocol preferred by the PRx is not supported). If the PRx supports the PTx’s current operating standard, the PRx may re-request a new power session using the PTx’s current operating standard (e.g., the second charging protocol). Alternatively, as shown in FIG. 8F, the PRx may choose to retrieve (e.g., 710) the standards supported by the PTx. If there is at least one commonly supported standard (e.g., at block 712), the PRx may select (e.g., at block 714) any commonly supported standard by resending PSR to request a new session. If there are no commonly supported standards (e.g., at block 712), the PRx ends the power session by sending an EPT message (e.g., at block 720) to cause the power transfer session to disconnect (e.g., block 722).

FIG. 8G illustrates a scenario where the PTx and the PRx are operating on mismatched standards and neither the PTx nor the PRx supports multiple standards, in accordance with some embodiments. As described with respect to FIG. 8A, there is an irreconcilable standard mismatch. As shown in FIG. 8G, the PRx may have the opportunity to fall back to a legacy version of the PTx’s standard, such as by sending an EPT/legacy message. For example, the PRx may send the EPT/legacy message to trigger a fallback to the legacy protocol when there is an irreconcilable standard mismatch but the PSS message indicates that a legacy mode is supported (e.g., a Legacy field of the PSS message is set to 1). Otherwise, the PTx may re-ping without changing protocol. The PRx may send the EPT/legacy message as the first packet after receiving the PSS message from the PTx to minimise the amount of time spent in a standard mismatch state. After an EPT/legacy triggered re-ping, the PTx enters into a legacy mode of operation (e.g., a restricted mode, such as a 128 kHz Restricted Mode). Accordingly, the system can enter a wireless power transfer phase, but using a legacy protocol.

Described above are various features and embodiments relating to interactions between devices to improve wireless power transfer in wireless power transfer systems. Such arrangements may be used in a variety of applications but may be particularly advantageous when used in conjunction with electronic devices such as mobile phones, tablet computers, laptop or notebook computers, and accessories, such as wireless headphones, styluses, etc. Additionally, although numerous specific features and various embodiments have been described, it is to be understood that, unless otherwise noted as being mutually exclusive, the various features and embodiments may be combined various permutations in a particular implementation. Thus, the various embodiments described above are provided by way of illustration only and should not be constructed to limit the scope of the disclosure. Various modifications and changes can be made to the principles and embodiments herein without departing from the scope of the disclosure and without departing from the scope of the claims.

The foregoing describes exemplary embodiments of wireless power transfer systems that are able to transmit certain information between the PTx and PRx in the system. The present disclosure contemplates this passage of information improves the devices’ ability to provide wireless power signals to each other in an efficient manner to facilitate power delivery, such as by determining levels of support between transmitting and receiving devices. Entities implementing the present technology would preferably need not employ the use of sensitive information in establishing wireless power delivery. In any event, to the extent any sensitive information is used in particular implementations to establish power delivery, for example for authentication, well-established privacy policies and/or privacy practices should be complied with. In particular, such entities would be expected to implement and consistently apply privacy practices that are generally recognized as meeting or exceeding industry or governmental requirements for maintaining the privacy of users. Implementers should inform users where personally identifiable information is expected to be transmitted in a wireless power transfer system and allow users to “opt in” or “opt out” of participation. For instance, such information may be presented to the user when they place a device onto a power transmitter, if the power transmitter is configured to poll for sensitive information from the power receiver.

What is claimed is:

1. A wireless power transmitter, comprising:
a wireless power transfer coil;
an inverter configured to receive input power and to generate an output to the wireless power transfer coil to wirelessly deliver power to a wireless power receiver; and
a controller coupled to the inverter and to the wireless power transfer coil that controls the inverter to regulate wireless power transfer to the wireless power receiver, wherein the controller communicates with the wireless power receiver by:
detecting presence of the wireless power receiver;
subsequent to detecting presence of the wireless power receiver, transmitting, to the wireless power receiver, a first startup message as part of a digital ping; and
subsequent to transmitting the first startup message:
in accordance with receiving, from the wireless power receiver, a first type of message that is a response based on the first startup message, negotiating wireless power transfer, using a first charging protocol, with the wireless power receiver; and
in accordance with receiving, from the wireless power receiver, a second type of message, different from the first type of message, that is not a response based on the first startup message, negotiating wireless power transfer, using a second charging protocol, with the wireless power receiver.

2. The wireless power transmitter of claim 1, wherein the first charging protocol is part of a first standard and the second charging protocol is part of a second standard, and wherein the first standard and the second standard are different wireless charging standards and/or different versions of a same wireless charging standard.

3. The wireless power transmitter of claim 1, wherein the first charging protocol and the second charging protocol are part of a same wireless charging standard, and wherein the first charging protocol supports a first power transfer level and the second charging protocol supports a second power transfer level that is different from the first power transfer level.

4. The wireless power transmitter of claim 1, wherein the first charging protocol is part of a standard and the second charging protocol is a proprietary protocol.

5. The wireless power transmitter of claim 1, wherein negotiating wireless power, using the first charging protocol, with the wireless power receiver comprises:
transmitting, to the wireless power receiver, a second startup message as part of the digital ping, wherein the second startup message is a response based on the received first type of message.

6. The wireless power transmitter of claim 5, wherein the second startup message includes an error status indicating whether the wireless power transmitter and the wireless power receiver support a compatible charging standard.

7. The wireless power transmitter of claim 5, wherein the second startup message includes an indication of a supported charging standard.

8. The wireless power transmitter of claim 5, wherein the wireless power transfer coil provides wireless power to the wireless power receiver at an initial power transfer level before the second startup message is transmitted.

9. The wireless power transmitter of claim 8, wherein the initial power transfer level is less than a first power transfer level that the first charging protocol supports.

10. The wireless power transmitter of claim 8, wherein the wireless power transfer coil provides wireless power to the wireless power receiver at a negotiated power transfer level that is higher than the initial power transfer level after negotiating wireless power transfer.

11. The wireless power transmitter of claim 1, wherein the controller communicates with the wireless power receiver by:
subsequent to transmitting the first startup message:
in accordance with receiving, from the wireless power receiver, a third type of message that is a response based on the first startup message, providing wireless power, via the wireless power transfer coil, to the wireless power receiver.

12. A computer-readable storage medium storing one or more programs configured to be executed by one or more processors of a wireless power transmitter that includes a wireless power transfer coil and an inverter configured to receive input power and to generate an output to the wireless power transfer coil to wirelessly deliver power to a wireless power receiver, the one or more programs including instructions for:
detecting presence of the wireless power receiver;
subsequent to detecting presence of the wireless power receiver, transmitting, to the wireless power receiver, a first startup message as part of a digital ping; and
subsequent to transmitting the first startup message:
in accordance with receiving, from the wireless power receiver, a first type of message that is a response based on the first startup message, negotiating wireless power transfer, using a first charging protocol, with the wireless power receiver; and
in accordance with receiving, from the wireless power receiver, a second type of message, different from the first type of message, that is not a response based on the first startup message, negotiating wireless power transfer, using a second charging protocol, with the wireless power receiver.

13. A method, comprising:
at a wireless power transmitter:
detecting presence of a wireless power receiver;
subsequent to detecting presence of the wireless power receiver, transmitting, to the wireless power receiver, a first startup message as part of a digital ping; and
subsequent to transmitting the first startup message:
in accordance with receiving, from the wireless power receiver, a first type of message that is a response based on the first startup message, negotiating wireless power transfer, using a first charging protocol, with the wireless power receiver; and
in accordance with receiving, from the wireless power receiver, a second type of message, different from the first type of message, that is not a response based on the first startup message, negotiating wireless power transfer, using a second charging protocol, with the wireless power receiver.
